(19) United States
(12) Patent Application Publication
(10) Pub. No.: US 2025/0112342 A1
(43) Pub. Date: Apr. 3, 2025

(54) SYSTEM FOR DENDRITE FORMATION SUPPRESSION IN SECONDARY BATTERIES

(71) Applicant: Honda Motor Co., Ltd., Tokyo (JP)

(72) Inventor: Phillip Andrew AQUINO, Columbus, OH (US)

(21) Appl. No.: 18/477,452

(22) Filed: Sep. 28, 2023

(51) Int. Cl. H01M 50/574; H01M 4/02; H01M 4/134; H01M 4/38; H01M 10/42

(52) U.S. Cl. CPC H01M 50/574; H01M 4/134; H01M 4/382; H01M 10/425; H01M 2004/027

(57) ABSTRACT

A secondary battery has two sets of electrode pairs, including metal anodes, on separate circuits. During charging, an applied current is switched back and forth between the two sets of electrode pairs. When one set is being charged, the other set is subject to an electrochemical potential opposite to a charging electrochemical potential, which may decay dendrites on the other set. The frequency of switching is performed at a high frequency that inhibits dendrite growth in the first place.

### BACKGROUND

Secondary batteries such as Lithium-ion batteries have become the main energy storage device for commercial electronics, including battery electric vehicles (BEV), due to their high performance and storage capacity capabilities compared to other technologies.

In the field of the secondary battery, there is the rolled or cylindrical format or prismatic format, in which only one cathode and one anode layer are rolled together while electrically isolated by a separator. The secondary battery also has a pouch format. With reference to the prior art secondary battery 106 in FIG. 1, within a typical pouch cell, there are many individual layers of anode 112 and cathode 114 pairs, respectively arranged on negative and positive current collectors 116, 118. The anode and cathode pairs are made ionically conductive by an electrolyte 124 and kept electrically isolated by a separator 126. During charging, electrons are stripped from the metal matrix of the cathodes 114, which yields a free cation to travel (as depicted schematically by the arrows) through an electrolyte 124 towards the anode 112, where the cation then oxidizes with the material in the anode 112 and re-bonds with the electrons, which have traveled through the attached circuit, including the positive battery terminal 122 and the negative battery terminal 120.

In the prior art secondary battery 106 as shown in FIG. 1, multiple anode and cathode sheets 112, 114 are wired together in parallel in order to increase the cell's 106 total charge capacity. A typical lithium-ion battery 106 (FIG. 1), e.g. in a cell phone, laptop, or BEV, may have on the order of 100 cathode/anode sheets. All the cathode sheets 114 are in electrical communication with the positive battery terminal 122 of the cell 106. All the anode sheets 112 are in electrical communication with the negative battery terminal 120 of the cell 106. All electrode pairs (cathode and anodes) will charge or discharge together.

### BRIEF DESCRIPTION

According to one aspect, a secondary battery includes a first positive battery terminal; a second positive battery terminal; a negative battery terminal; a first electrode pair electrically connected to the first positive battery terminal and the negative battery terminal; and a second electrode pair electrically connected to the second positive battery terminal and the negative battery terminal.

According to another aspect, a secondary battery system includes a negative system terminal; a positive system terminal; a first positive battery terminal; a second positive battery terminal; a series of electrode pairs; and a controller. Each electrode pair in the series of electrode pairs includes an anode and a cathode. The series of electrode pairs includes a first set of electrode pairs electrically connected to the first positive battery terminal, and a second set of electrode pairs electrically connected to the second positive battery terminal. The controller repeatedly and alternately electrically connects the positive system terminal to a) the first positive battery terminal, and b) the second positive battery terminal.

According to another aspect, a secondary battery system includes a series of electrode pairs, each electrode pair in the series of electrode pairs including an anode and a cathode; a negative system terminal; a positive system terminal; and a controller repeatedly and sequentially electrically connecting the series of electrode pairs to the positive system terminal and the negative system terminal. The cathode of a first electrode pair in the series of electrode pairs and the cathode of a last electrode pair in the series of electrode pairs are arranged on a common positive current collector, or the anode of the first electrode pair in the series of electrode pairs and the anode of the last electrode pair in the series of electrode pairs are arranged on a common negative current collector.

### BRIEF DESCRIPTION OF THE DRAWINGS

FIG. 1 is a schematic cross section view of a prior art secondary battery during charging.

FIG. 2 is a schematic cross section view of a secondary battery according to the present subject matter.

FIG. 3 is the secondary battery of FIG. 2 showing charging of two of the electrode pairs.

FIG. 4 is the secondary battery of FIG. 2 showing charging of another two of the electrode pairs.

FIG. 5 is a series of graphs showing predicted dendrite growth on anodes using different charging strategies.

FIG. 6 is a schematic cross section view of a secondary battery according to the present subject matter during charging and recharging.

FIG. 7 is the secondary battery of FIG. 2 during discharging.

FIG. 8 is the secondary battery of FIG. 6 during discharging.

### DETAILED DESCRIPTION

Lithium-ion (L-ion) battery packs used for BEV's are relatively large due to the low specific energy density of the lithium-ion battery, and thus these battery packs are a sizeable fraction of the total vehicle weight. Current L-ion batteries have a low specific energy density of about 200 Wh/kg, while gasoline, in contrast, has about 13,000 Wh/kg. Increasing the specific energy density of the cell is desired. Lithium metal anodes are seen as one of the main technological breakthroughs that could achieve an industry target specific energy density of greater than 300 Wh/kg. However, a technical problem with the use of metal anodes in secondary batteries is that they tend to produce metal dendrites (a tree like structure of deposited metal on the surface of the anode) which is a safety concern. For example, in case of a lithium-ion battery, the lithium metal dendrites may be produced on the surface of the anode. If a dendrite is allowed to grow indefinitely, it will eventually grow until making direct contact with the cathode, which creates an internal short circuit within the cell. This may lead to a fire or an explosion, the threat of which has heretofore prevented lithium metal anodes from being commercialized.

Dendrite formation continues to be an active area of research. For a lithium metal anode, one would ideally expect that during charging, the lithium ions would deposit uniformly on the lithium metal anode surface in a thin plating layer. As more and more lithium ions were deposited, the thickness of this layer of plated lithium on the anode would increase. However, this ideal is not realized in actual practice, and such a thin-plated lithium metal layer is not observed in on actual lithium metal anode batteries. Rather, the lithium ions tend to deposit in localized preferential regions on the surface of the anode. Subsequently deposited lithium ions strongly prefer to aggregate on top of these local accumulations of lithium (referred to as lithium filaments), which causes a self-reinforcement of localized accumulation, which results in the formation of a relatively tall tree-like structure of deposited lithium extending away from the anode surface toward the separator and cathode surface, and these structures are known as dendrites. These preferential regions of deposition occur due to a number of non-ideal circumstances such as imperfect distribution of material within the cell, which can create local diffusive pathways with shorter distances and less restriction than in other regions of the cell. The lithium ions thus have preferred deposition sites and lithium-ion deposition is non-uniformly distributed, and so dendrite formation is very difficult to avoid in practice, especially if lithium metal anodes are used.

One embodiment of the present subject matter is a lithium-ion battery, a lithium-ion battery system, and related methods, which discourage the formation of lithium dendrites during charging even while using lithium metal anodes. A lithium metal anode may be used, and may increase the specific energy density of the secondary battery system as compared to a graphite anode. In the present subject matter, rather than utilizing all of the cell's cathode and anode sheets during charging or discharging, a controller (e.g. a switching device and accompanying circuitry) will selectively activate or deactivate one or more electrode pairs within the cell. For this purpose, the cell has two or more independent electrical paths, as opposed to the singular electrical path used in conventional batteries. This configuration may allow regions of the cell to be selectively utilized independently for charging or discharging. This selective utilization may allow a constant current to be passed into the cell during charging, but with alternate switching of the applied current between one or more independent electrical paths within the cell.

Without being bound to any particular theory, independent use of these electrical paths for charging may discourage dendrite formation by switching the primary direction of the negative gradient of electric potential to be in an unfavorable direction for dendrite formation.

### 1. Secondary Battery System

Referring to the figures, a secondary battery system 2 includes a controller 4 and a secondary battery 6. The controller 4 may be operatively connected to the secondary battery 6. The controller 4 and the secondary battery 6 may be a single unit, or may be separate from each other and selectively operatively connectable to each other.

The secondary battery system 2 includes a positive system terminal 8 and a negative system terminal 10 for connecting with an external circuit. The external circuit may include a first external circuit comprising a power source (not shown) for charging the secondary battery 6, and a second external circuit comprising a load (not shown) for discharging the secondary battery 6, or to a single external circuit connectable to the load or the power source. The controller 4 may define the positive system terminal 8, and optionally the negative system terminal 10.

The controller 4 may be part of a separate device from the secondary battery 6, such as the controller 4 being part of a separate device to recharge, or be powered by, the secondary battery 6, and thus may be selectively operatively connected with the secondary battery 6 to form the secondary battery system 2. The controller 4 may be used during (re) charging or discharging of the secondary battery 6. When the secondary battery 6 is not being charged or discharged, the controller 4 and the secondary battery 6 may be separated and/or not operatively connected.

The controller 4 may be integral with the secondary battery 6, such as to be operatively connected therewith and thus define the secondary battery system 2 as one single unit. The controller 4 may be permanently connected to the secondary battery 6 and thus not separable without damaging the controller 4 and/or secondary battery 6. The controller 4 may be removably connected to the secondary battery 6, thus being separable without damaging the controller 4 or the secondary battery 6, which may allow the controller 4 to be used with another secondary battery 6.

### 2. Secondary Battery

The secondary battery 6 includes a plurality of electrode pairs. Each electrode pair of the plurality of electrode pairs includes an anode 12 and a cathode 14. The anode 12 is arranged on a negative current collector 16, and the cathode 14 is arranged on a positive current collector 18. The anode 12 may include lithium metal as an anode active material.

The anode 12 is electrically connected via the negative current collector 16 to a negative battery terminal 20, which may or may not define the negative system terminal 10 as explained in more detail herein. The cathode 14 is electrically connected via the positive current collector 18 to a positive battery terminal 22, which is distinct from the positive system terminal 8 but selectively connectable thereto by the controller 4. An electrolyte 24 is arranged between the anode 12 and cathode 14. A separator 26 is arranged in the electrolyte 24 between the anode 12 and the cathode 14 to separate the anode 12 and the cathode 14. The secondary battery 6 includes at least two electrode pairs, at least two positive battery terminals 22 and at least one negative battery terminal 20.

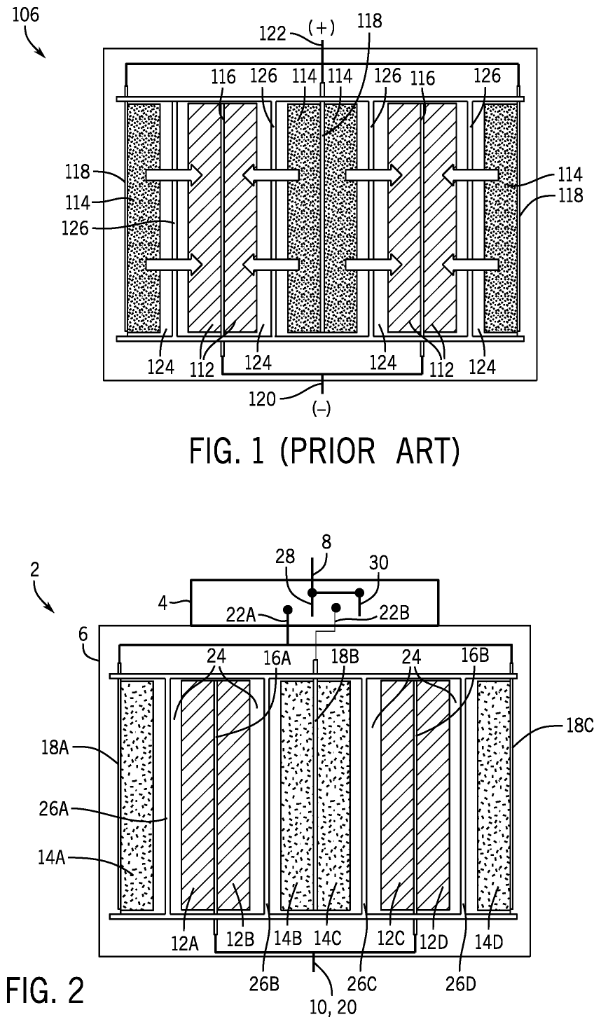

As shown in FIGS. 2-4 and 7, the secondary battery 6 includes a plurality of electrode pairs, including a first electrode pair including a first anode 12A and a first cathode 14A, a second electrode pair including a second anode 12B and a second cathode 14B, a third electrode pair including a third anode 12C and a third cathode 14C, and a fourth electrode pair including a fourth anode 12D and a fourth cathode 14D. The secondary battery 6 can include more than these four electrode pairs.

The first cathode 14A is a half cathode and is arranged on a first positive current collector 18A. The second cathode 14B and the third cathode 14C are each half anodes and are arranged on either side of a second positive current collector 18B to make a full cathode. The fourth cathode 14D is a half cathode and arranged on a third positive current collector 18C. As depicted, the first cathode 14A and the fourth cathode 14D are half cathodes in that they do not have another corresponding half cathode arranged on the other side of their respective current collector 18.

The first anode 12A and the second anode 12B are adjacent, and are arranged on a common (i.e. the same one) first negative current collector 16A, and the third anode 12C and the fourth anode 12D are adjacent, and arranged on a common second negative current collector 16B.

The secondary battery 6 includes a first positive battery terminal 22A, a second positive battery terminal 22B, and a negative battery terminal 20, which negative battery terminal 20 may define the negative system terminal 10 as shown in FIGS. 2-4 and 7. A first set of electrode pairs of the plurality of electrode pairs is electrically connected to the first positive battery terminal 22A via their respective cathodes 14. The first set of electrode pairs includes as least the first electrode pair, and optionally the fourth electrode pair and any other electrode pair (not shown) that is electrically connected to the first positive battery terminal 22A via their respective cathodes 14. A second set of electrode pairs of the plurality of electrode pairs is electrically connected to the second positive battery terminal 22B via their respective cathodes 14. The second set of electrode pairs includes as least the second electrode pair, and optionally the third electrode pair and any other electrode pair (not shown) that is electrically connected to the second positive battery terminal 22B via their respective cathodes 14.

The first and fourth electrode pairs may be part of the first set of electrode pairs because they are electrically connected to the first positive battery terminal 22A via their respective cathodes 14A, 14D and respective positive current collectors 18A, 18C. The second and third electrode pairs may be part of the second set of electrode pairs because they are electrically connected to the second positive battery terminal 22B via their respective cathodes 14B, 14C and the positive current collector 18B.

The first electrode pair is electrically connected to the first positive battery terminal 22A and the negative system/battery terminal 10, 20, wherein the first cathode 14A is electrically connected to the first positive current collector 18A, which is electrically connected to the first positive battery terminal 22A, and the first anode 12A is electrically connected to the first negative current collector 16A, which is electrically connected to the negative system/battery terminal 10, 20.

The second electrode pair is electrically connected to the second positive battery terminal 22B and the negative system/battery terminal 10, 20, wherein the second cathode 14B is electrically connected to the second positive current collector 18B, which is electrically connected to the second positive battery terminal 22B, and the second anode 12B is electrically connected to the first negative current collector 16A, which is electrically connected to the negative system/battery terminal 10, 20.

The third electrode pair is electrically connected to the second positive battery terminal 22B and the negative system/battery terminal 10, 20, wherein the third cathode 14C is electrically connected to the second positive current collector 18B, which is electrically connected to the second positive battery terminal 22B, and the third anode 12C is electrically connected to the second negative current collector 16B, which is electrically connected to the negative system/battery terminal 10, 20.

The fourth electrode pair is electrically connected to the first positive battery terminal 22A and the negative system/battery terminal 10, 20, wherein the fourth cathode 14D is electrically connected to the third positive current collector 18C, which is electrically connected to the first positive battery terminal 22A, and the fourth anode 12D is electrically connected to the second negative current collector 16B, which is electrically connected to the negative system/battery terminal 10, 20.

As shown in FIGS. 6 and 8, the secondary battery 6 is similar to that shown in FIGS. 2-4 and 7, wherein similar features have similar reference numbers, the description of which will not be repeated. The secondary battery 6 of FIGS. 6 and 8 differ from FIGS. 2-4 and 7 in that the secondary battery 6 of FIGS. 6 and 8 includes a first negative battery terminal 20A and a second negative battery terminal 20B that do not define the negative system terminal 10. The first and second electrode pairs of the plurality of electrode pairs are electrically connected to the first negative battery terminal 20A. The third and fourth electrode pairs of the plurality of electrode pairs are electrically connected to the second negative battery terminal 20B.

The first negative current collector 16A is electrically connected to the first negative battery terminal 20A, and thus the first negative current collector 16A electrically connects the first and second anodes 12A, 12B to the first negative battery terminal 20A. The second negative current collector 16B is electrically connected to the second negative battery terminal 20B, and thus the second negative current collector 16B electrically connects the third and fourth anodes 12C, 12D to the second negative battery terminal 20B. In the embodiments shown in shown in FIGS. 6 and 8, as depicted in phantom in the figures, the secondary battery 6 may have a circular configuration, wherein the first cathode 14A and the last cathode (e.g. the fourth cathode 14D as shown in the figures) are arranged on one positive current collector, i.e. the first positive current collector 18A and the third positive current collector 18C are the same positive current collector, and thus the first cathode 14A and the fourth cathode 14D together form a full cathode by being physically connected to the same positive current collector.

### 3. Controller

The controller 4 includes switching circuitry, which may be operated automatically, to electrically connect the system terminal(s) with the secondary battery terminals, and thus may selectively electrically connect each of the plurality of electrode pairs to an external circuit (i.e. power source and/or load). The controller 4 includes a first switch 28 and a second switch 30. The controller may include additional switches. The controller 4 includes the positive system terminal 8 (FIGS. 2-4, 6-8), and may also include the negative system terminal 10 (FIGS. 6 and 8). Thus the controller 4 is configured to repeatedly and alternately establish an electrical connection between an external circuit with one of a) the first set of electrode pairs and b) the second set of electrode pairs.

The first switch 28 may selectively electrically connect the positive system terminal 8 to a) the first positive battery terminal 22A in a first configuration, and b) the second positive battery terminal 22B in a second configuration. The first switch 28 may also be used to selectively electrically connect the positive system terminal 8 to additional positive battery terminals (not shown) if present.

FIG. 2 shows the first switch 28 making no electrical connection with either of the first or second positive battery terminals 22A, 22B. The first switch 28 is at a middle configuration not electrically contacting either of the first or second positive battery terminals 22A, 22B, and thus neither of the first or second positive battery terminals 22A, 22B are electrically connected to the positive system terminal 8. This configuration may be present when the secondary battery 6 is not in use, e.g. not being charged or discharged.

FIG. 4 shows the first switch 28 in the first configuration, making an electrical connection with the first positive battery terminal 22A and not with the second positive battery terminal 22B. The first positive battery terminal 22A is electrically connected via the first switch 28 to the positive system terminal 8, and thus an electrical current can travel between the positive and negative system terminals 8, 10 via the first and fourth electrode pairs, which first and fourth electrode pairs are thereby considered “activated,” while the second and third electrode pairs are considered “deactivated” because they are not electrically connected to the positive and negative system terminals 8, 10. This configuration may be present when the secondary battery 6 is in use, e.g. during charging of the secondary battery 6. This configuration is not present in the prior art secondary battery 106, since all the electrodes are “activated” at all times because they are all electrically connected to common battery terminals 120, 122.

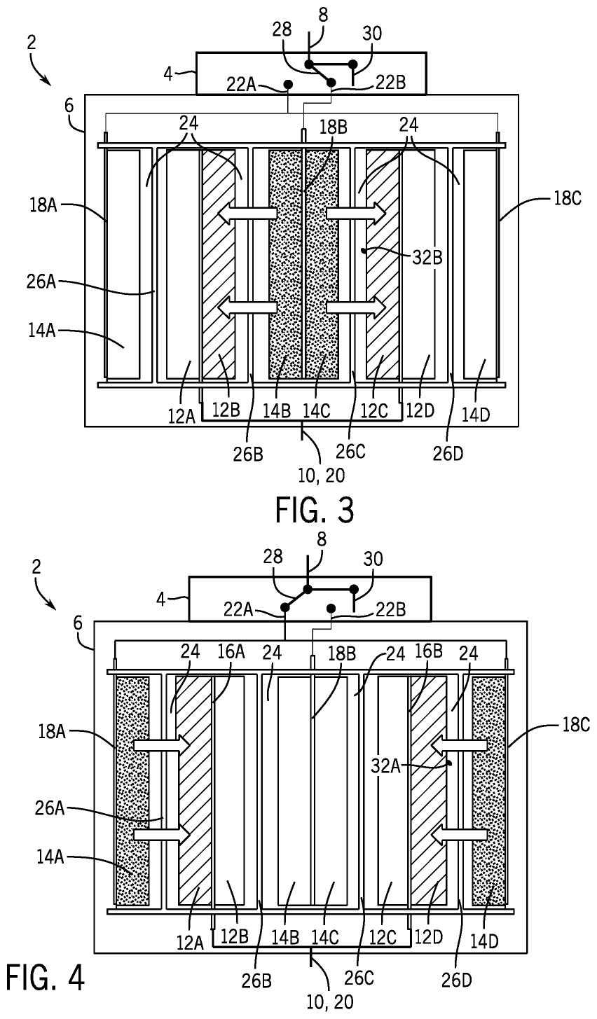

FIG. 3 shows the first switch 28 in the second configuration, making an electrical connection with the second positive battery terminal 22B and not with the first positive battery terminal 22A. The second positive battery terminal 22B is electrically connected via the first switch 28 to the positive system terminal 8, and thus an electrical current can travel between the positive and negative system terminals 8, 10 via the second and third electrode pairs, which second and third electrode pairs are thereby considered “activated,” while the first and fourth electrode pairs are considered “deactivated” because they are not electrically connected to the positive and negative system terminals 8. This configuration may be present when the secondary battery 6 is in use, e.g. during charging of the secondary battery 6.

The second switch 30 may selectively electrically connect the positive system terminal 8 to the second positive battery terminal 22B. FIGS. 2-4 show the second switch 30 making no electrical connection with the second positive battery terminal 22B. The second switch 30 is not electrically contacting the second positive battery terminal 22B, and thus the second positive battery terminal 22B is not electrically connected to the positive system terminal 8 via the second switch 30. This configuration may be present when the secondary battery 6 is in use, e.g. during charging of the secondary battery 6.

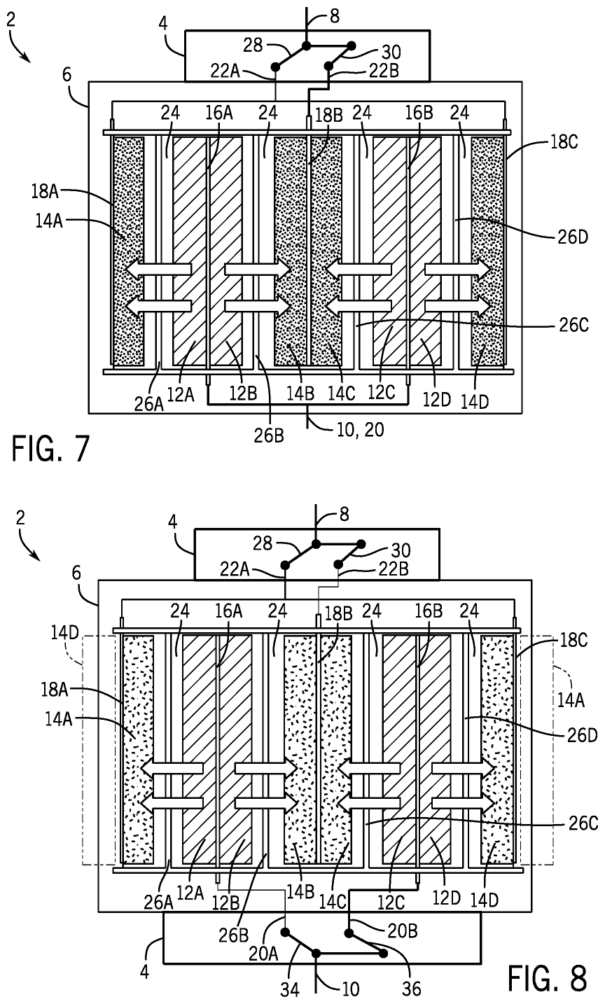

FIG. 7 shows the second switch 30 in a first configuration making an electrical connection with the second positive battery terminal 22B. The second positive battery terminal 22B is electrically connected via the second switch 30 to the positive system terminal 8, and thus an electrical current can travel between the positive and negative system terminals 8, 10 via the second and third electrode pairs, which second and third electrode pairs are thereby considered activated because they are electrically connected to the positive and negative system terminals 8, 10. The first switch 28 is also making an electrical connection with the first positive battery terminal 22A, thus also activating the first and fourth electrode pairs. This configuration, where all of the plurality of electrode pairs are activated, may be present when the secondary battery 6 is in use, e.g. during discharging of the secondary battery 6, which is shown schematically by the arrows indicating Li⁺ transport from anodes 12 to cathodes 14.

The controller 4 may include a third switch 34 and a fourth switch 36. This configuration, shown in FIGS. 6 and 8, allows for individual activation of one electrode pair at a time for charging, and for simultaneous activation of all the electrode pairs for discharging.

The third switch 34 may selectively electrically connect the negative system terminal 10 to a) the first negative battery terminal 20A, and b) the second negative battery terminal 20B. The third switch 34 may also be used to selectively electrically connect the negative system terminal 10 to additional negative battery terminals (not shown) if present.

FIG. 6 shows the third switch 34 making an electrical connection with either the first or second negative battery terminals 20A, 20B. As shown in dotted lines, the third switch 34 can toggle between a first configuration (dotted line on the left in the drawing) and a second configuration (dotted line on the right in the drawing).

When in the first configuration, the third switch 34 makes an electrical connection with the first negative battery terminal 20A and not with the second negative battery terminal 20B. The first negative battery terminal 20A is electrically connected via the third switch 34 to the negative system terminal 10. When the first switch 28 is moved to the first configuration, and thus electrically connecting the first positive battery terminal 22A with the positive system terminal 8, an electrical current can travel between the positive and negative system terminals 8, 10 via the first electrode pair, which is then individually activated while no other electrode pairs are activated. When the first switch 28 is moved to the second configuration, and thus electrically connecting the second positive battery terminal 22B with the positive system terminal 8, an electrical current can travel between the positive and negative system terminals 8, 10 via the second electrode pair, which is then individually activated while no other electrode pairs are activated.

When in the second configuration, the third switch 34 makes an electrical connection with the second negative battery terminal 20B and not with the first negative battery terminal 20A. The second negative battery terminal 20B is electrically connected via the third switch 34 to the negative system terminal 10. When the first switch 28 is moved to the second configuration, and thus electrically connecting the second positive battery terminal 22B with the positive system terminal 8, an electrical current can travel between the positive and negative system terminals 8, 10 via the third electrode pair, which is then individually activated while no other electrode pairs are activated. When the first switch 28 is moved to the first configuration, and thus electrically connecting the first positive battery terminal 22A with the positive system terminal 8, an electrical current can travel between the positive and negative system terminals 8, 10 via the fourth electrode pair, which is then individually activated while no other electrode pairs are activated. These configurations of individual activation of the plurality of electrode pairs may be present when the secondary battery 6 is in use, e.g. during charging of the secondary battery 6.

When used in conjunction, the first switch 28 and third switch 34 can individually activate each electrode pair in the plurality of electrode pairs. For example, the first electrode pair could be activated by having the first switch 28 make an electrical connection to the first positive battery terminal 22A, and thus make an electrical connection between the positive system terminal 8 and the first positive battery terminal 22A, and the third switch 34 make an electrical connection to the first negative battery terminal 20A, and thus make an electrical connection between the positive system terminal 8 and the first positive battery terminal 22A, and between the negative system terminal 10 and the first negative battery terminal 20A. This forms a circuit between the positive system terminal 8 and the negative system terminal 10 via the first electrode pair.

The second electrode pair could be activated by having the first switch 28 make an electrical connection to the second positive battery terminal 22B, and the third switch 34 make an electrical connection to the first negative battery terminal 20A. This forms a circuit between the positive system terminal 8 and the negative system terminal 10 via the second electrode pair. The third electrode pair could be activated by having the first switch 28 make an electrical connection to the second positive battery terminal 22B, and the third switch 34 make an electrical connection to the second negative battery terminal 20B. This forms a circuit between the positive system terminal 8 and the negative system terminal 10 via the third electrode pair. The fourth electrode pair could be activated by having the first switch 28 make an electrical connection to the first positive battery terminal 22A, and the third switch 34 make an electrical connection to the second negative battery terminal 20B. This forms a circuit between the positive system terminal 8 and the negative system terminal 10 via the fourth electrode pair.

The fourth switch 36 may selectively electrically connect the negative system terminal 10 to the second negative battery terminal 20B. FIG. 6 shows the fourth switch 36 making no electrical connection with the second negative battery terminal 20B. The fourth switch 36 is not electrically contacting the second negative battery terminal 20B, and thus the second negative battery terminal 20B is not electrically connected to the negative system terminal 10 via the fourth switch 36. This configuration may be present when the secondary battery 6 is in use, e.g. during charging of the secondary battery 6.

FIG. 8 shows the fourth switch 36 in a first configuration making an electrical connection with the second negative battery terminal 20B. The second positive negative terminal 22B is electrically connected via the fourth switch 36 to the negative system terminal 10. If the first and second switches 28, 30 are also in the first configuration respectively making electrical contact with the first and second positive battery terminals as shown in FIG. 8, then an electrical current can travel between the positive and negative system terminals 8, 10 via the third and fourth electrode pairs. If the third switch 34 is also in the first configuration making electrical contact with the first negative battery terminal 20A, then an electrical current can travel between the positive and negative system terminals 8, 10 via the first and second electrode pairs. This configuration, where all of the plurality of electrode pairs are activated, may be present when the secondary battery 6 is in use, e.g. during discharging of the secondary battery 6, which is shown schematically by the arrows indicating Li⁺ transport from anodes 12 to cathodes 14.

### 4. Methods

A method of using the secondary battery system 2 may include (re) charging the secondary battery 6. The secondary battery 6 may be charged by activating (i.e. electrically connecting to the system terminals 8, 10) all or some of the electrode pairs. When the system terminals 8, 10 are electrically connected to a power source, the power source will provide the applied current to (i.e. charge) the activated electrode pairs.

The method includes repeatedly and alternately delivering, via the positive system terminal 8 and the negative system terminal 10, an applied current to a) the first set of electrode pairs, and b) the second set of electrode pairs, to thereby charge the secondary battery 6.

When the electrical connection in FIG. 4 is made by the first switch 28 being in the first configuration, an applied current can be delivered to the secondary battery 6 to charge the activated first set of electrode pairs of the secondary battery 6, which applied current will flow through the positive system terminal 8, the first switch 28, the first positive battery terminal 22A, the first set of electrode pairs, and the negative system/battery terminal 10, 20.

When the electrical connection in FIG. 3 is made by the first switch 28 being in the second configuration, an applied current can be delivered to the secondary battery 6 to charge the activated second set of electrode pairs of the secondary battery 6, which applied current will flow through the positive system terminal 8, the first switch 28, the second positive battery terminal 22B, the second set of electrode pairs, and the negative system/battery terminal 10, 20.

When the applied current is being delivered to the activated set of electrode pairs during charging of the battery, metal (e.g. lithium metal in case of lithium-ion battery) dendrites may form on the anodes 12 of the first set of electrode pairs. FIG. 4 depicts a dendrite 32A growing on the fourth anode 12D. When the applied current is being delivered to the activated second set of electrode pairs during charging of the battery, metal (e.g. lithium metal in case of lithium-ion battery) dendrites may form on the anodes 12 of the second set of electrode pairs. FIG. 3 depicts a dendrite 32B growing on the third anode 12C.

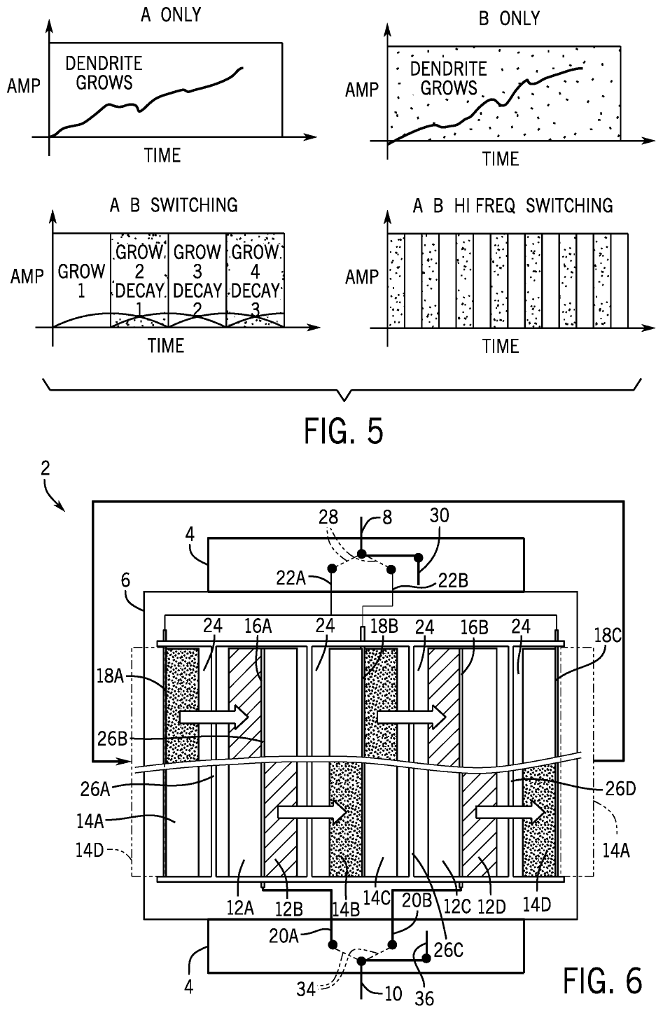

While not being bound to any particular theory, it is believed that when the applied current is being delivered to the activated electrode pairs, the anodes 12 of the deactivated electrode pairs are subject to an electrochemical potential opposite to a charging electrochemical potential, which may cause a dendrite 32 on the deactivated anodes 12 to shrink, i.e. by causing cations (e.g. lithium ions in case of lithium-ion battery) from the dendrite 32 to move back into the electrolyte 24. For instance, it is believed that when the applied current is being delivered to the activated second and third electrode pairs, that the first and fourth electrode pairs are subject to an electrochemical potential opposite to a charging electrochemical potential, which may cause a dendrite 32A that may be on the first and fourth anodes 12A, 12D to shrink, i.e. by causing cations (e.g. lithium ions in case of lithium-ion battery) from the dendrite 32A to move back into the electrolyte 24. It is also believed that when the applied current is being delivered to the activated first and fourth electrode pairs, that the second and third electrode pairs are subject to an electrochemical potential opposite to a charging electrochemical potential, which may cause a dendrite 32B that is on the second and third anodes 12B, 12C to shrink, i.e. by causing cations (e.g. lithium ions in case of lithium-ion battery) from the dendrite 32B to move back into the electrolyte 24. Charging of the second and third electrode pairs thus reverses the dendrite formation caused by charging the first and fourth electrode pairs. It is believed that formation of the dendrites 32 is related to the amperage level of the applied current and the length of time at which the applied current is supplied. This is schematically shown in FIG. 5, wherein the first graph shows what could be typical dendrite growth on the first and fourth anodes 12A, 12D over time at a constant amperage, and the second graph shows what could be typical dendrite growth on the second and third anodes 12B, 12C over time at a constant amperage.

To account for this, the applied current is repeatedly and alternately delivered to a) the first set of electrode pairs, and 2) the second set of electrode pairs at a constant amperage but over small time intervals. This is schematically shown in FIG. 5, wherein the third graph shows repeated and alternating delivery of the constant amperage applied current to the a) the first set of electrode pairs, and 2) the second set of electrode pairs. The length of time at which the constant-amperage applied current is delivered to the first set of electrode pairs is shortened from that in the first graph, and thus the dendrite growth on the anodes of the first set of electrode pairs is reduced as shown. Moreover, when the applied current is switched to be supplied to the second set of electrode pairs (which causes dendrite growth on the anodes of the second set of electrode pairs), the dendrites on the deactivated anodes 12 are reduced in size because they are subject to an electrochemical potential opposite to a charging electrochemical potential. The same is thought to be true for dendrites that form on the anodes 12 of the second set of electrode pairs when the applied current is switched back to being delivered to the first set of electrode pairs. The third graph of FIG. 5 thus shows what could be reduced dendrite growth and shrinkage of the dendrites when the applied current is switched between a) the first set of electrode pairs, and 2) the second set of electrode pairs. The bottom fourth graph of FIG. 5 shows an even higher frequency switching of the applied current at a constant amperage between a) the first set of electrode pairs, and 2) the second set of electrode pairs. To start forming dendrites 32, a threshold charging current is applied for a threshold time. If the applied current is kept constant above the threshold current, but the time at which the applied current is delivered to a particular electrode pair is kept below the threshold time, then it is thought that dendrites 32 will not form on the anode 12 of that particular electrode pair. As depicted in the bottom graph of FIG. 5, the length of time of delivering the applied current to a) the first set of electrode pairs, and 2) the second set of electrode pairs, is so short and is switched/alternated between them at such a high frequency, i.e. applied to the sets for a duration that is below the threshold time, that the dendrites 32 might not grow or might not grow to a significant size, and otherwise could be shrunk due to their anodes experiencing the electrochemical potential opposite to a charging electrochemical potential upon delivery of the applied current to the other set of electrode pairs. That is, the applied current is delivered at or above the threshold current, but is switched at a frequency that inhibits dendrite growth in the first place on the activated anode, and otherwise diminishes the size of any dendrites that may be on non-activated anodes.

The applied current may be supplied from a power source electrically connected to the positive system terminal 8. The applied current may be delivered to the first set of electrode pairs through the positive system terminal 8, and through the first positive battery terminal 22A. For this, the first switch 28 may be in the first configuration to activate the first and fourth electrode pairs via the first positive battery terminal 22A. The applied current is delivered to the first set of electrode pairs (including the first electrode pair, and optionally the fourth electrode pair and other additional electrode pairs that are electrically connected to the first positive battery terminal 22A) and then out of the negative system terminal 10 back to the power source, thus charging the first and fourth electrode pairs as schematically shown by arrows in FIG. 4, representing a charging electrochemical potential and the transport of Li⁺ between the first and fourth cathodes 14A, 14D and the respective first and fourth anodes 12A, 12D. Such charging of the first and fourth electrode pairs exerts a charging electrochemical potential to the respective first and fourth anodes 12A, 12D, and may thus cause dendrite 32 growth on the first and fourth anodes 12A, 12D. FIG. 4 shows a dendrite 32A growing on the fourth anode 12D of the fourth electrode pair. A similar dendrite 32 may also grow on the first anode 12A of the first anode pair.

Dendrite 32 growth on the first and fourth anodes 12A, 12D may be counteracted by stopping delivery of the applied current to the first and fourth electrode pairs, and instead delivering the applied current to the second set of electrode pairs (including the second electrode pair, and optionally the third electrode pair and other additional electrode pairs that are electrically connected to the second positive battery terminal 22B). The applied current may be delivered to the second set of electrode pairs through the positive system terminal 8, and through the second positive battery terminal 22B. For this, the first switch 28 of the controller 4 may be in the second configuration to activate the second and third electrode pairs via the second positive battery terminal 22B. The applied current is delivered to the second set of electrode pairs and out of the negative system terminal 10 back to the power source, thus charging the second and third electrode pairs as schematically shown by arrows in FIG. 3, representing a charging electrochemical potential and the transport of Li⁺ between the second and third cathodes 14B, 14C and the respective second and third anodes 12B, 12C. Charging of the second and third electrode pairs may cause dendrites 32 that may have formed on the first and fourth anodes 12A, 12D to shrink under the affect of an electrochemical potential being applied to them that is opposite to the charging electrochemical potential. Such charging of the second and third electrode pairs also exerts a charging electrochemical potential to the respective first and fourth anodes 12A, 12D, and may thus cause dendrite 32 growth on the respective second and third anodes 12B, 12C. FIG. 3 shows a dendrite 32 growing on the third anode 12C of the third electrode pair. A similar dendrite 32 may also grow on the second anode 12B of the second anode pair. Subsequent switching back delivery of the applied current to the first set of electrode pairs may cause dendrites 32 that may have formed on the second and third anodes 12B, 12C to shrink under the effect of an electrochemical potential being applied to them that is opposite to the charging electrochemical potential. Thus switching of delivery of the applied current between the first and second sets of electrode pairs may inhibit dendrite growth.

Such method of recharging can be accomplished in the secondary battery system 2 of FIGS. 2-4 by toggling the first switch 28 between the first and second configurations. The switching of the delivery of the applied current between the first and second sets of electrode pairs may occur at a frequency that inhibits dendrite 32 growth on the anodes as a result of the short period of time at which the charging electrochemical potential is applied to the individual anodes 12, thus reducing the possibility of dendrite 32 growth in the first place, and thus reducing any possible need to shrink dendrites 32 with an application of electrochemical potential that is opposite to the charging electrochemical potential.

Typical processes of dendrite growth at a constant amperage of the applied current is show in FIG. 5. The top graph of FIG. 5 shows typical dendrite size on anodes of the first set of electrode pairs over time at a constant amperage of the applied current. As seen, dendrite size will generally increase over time. The second graph of FIG. 5 shows typical dendrite size on anodes of the second set of electrode pairs over time at a constant amperage for the applied current. As seen, dendrite size will generally increase over time as in the first graph. The third graph of FIG. 5 shows what is believed to be dendrite growth on anodes of the first and second sets of electrode pairs over time at a constant amperage of the applied current, but with repeated switching of the applied current back and forth between the first and second set of electrode pairs. As seen, dendrite will form and their size will generally increase (referred to herein as “grow” or “growing”) on the anodes of the first set of electrode pairs when the applied current is delivered thereto. However, when the applied current is switched to be delivered to the second set of electrode pairs, the dendrites on the anodes of the first set of electrode pairs will generally decrease in size (referred to herein as “decay” or “decaying”), while at the same time dendrites will form and their size will generally increase on the anodes of the second set of electrode pairs. However, when the applied current is again switched back to be delivered to the first set of electrode pairs, the dendrites on the anodes of the second set of electrode pairs will generally decay, while again the dendrites on the anodes of the first set of electrode pairs will again grow. Repeatedly and alternately delivering (i.e. repeated switching of the delivery) the applied current to a) the first set of electrode pairs and b) the second set of electrode pairs may thus inhibit the growth of dendrites on the anodes 12 of the secondary battery 6. The bottom graph of FIG. 5 shows what is believed to be dendrite growth during high-frequency switching of the delivery of the applied current between the first and second set of electrode pairs at a constant amperage over time. As seen, the time at which the applied current is delivered to each set of electrode pairs during each cycle of the switching is relatively short, i.e. the frequency of switching is relatively very high. Because of this, the time at which the applied current can cause dendrite growth on the anode of each set of electrode pairs is very short, and thus dendrite growth may be minimal or even non-existent. Any dendrite growth that may occur on anodes in one set of electrode pairs could be counteracted with dendrite decay caused by being subject to an electrochemical potential opposite to a charging electrochemical potential due to the delivery of the applied current to the other set of electrode pairs. The frequency at which delivery of the applied current is switched between the first and second set of electrode pairs could be (pre) determined by testing, by sensors associated with the secondary battery system 2, by user input, or otherwise, and thus can be set at a level at which dendrite growth is inhibited.

A method of using the secondary battery system 2 of FIG. 6 may include (re) charging the secondary battery 6 and discharging the secondary battery 6. The secondary battery 6 can be charged in a similar way as shown in FIGS. 3-4, by having the third switch 34 in the first configuration, having the fourth switch 36 electrically contacting the second negative battery terminal 20B, and then toggling the first switch 28 between the first and second configurations.

Alternately, and with reference to the top half of FIG. 6, the secondary battery 6 can be charged by delivering the applied current only to the first pair of electrodes, or only to the third pair of electrodes. With reference to the bottom half of FIG. 6, the secondary battery 6 can be discharged by drawing power from only the second set of electrodes or only from the fourth pair of electrodes. A cycle of charging and discharging the secondary battery 6 can include the following series of steps a)-d) in order, which order can be repeated (i.e. cycled): a) activating only to the first pair of electrodes and delivering the applied current only to the first pair of electrodes, e.g. from a power source, to thereby charge the secondary battery 6; b) activating only to the second pair of electrodes and drawing power only from the second pair of electrodes, e.g. to a load, to thereby discharge the secondary battery 6; c) activating only to the third pair of electrodes and delivering the applied current only to the third pair of electrodes to thereby charge the secondary battery 6; and d) activating only to the fourth pair of electrodes and drawing power only from the fourth pair of electrodes to thereby discharge the secondary battery 6. Steps a)-d) may be performed in order and can be repeated as many times as desired. If steps a)-d) are performed in order, Li⁺ may be transported in one direction, rather than oscillating back and forth between only one pair of electrodes, along the series of electrode pairs. This is shown schematically in FIG. 6 by arrows representing the flow of Li⁺ from left to right due to the alternating charging electrochemical potential and discharging electrochemical potential applied along the series of electrode pairs. For this to occur, the current collectors 16, 18 and separators 26 may be porous to Lit. As such, sequentially activating the electrode pairs as shown in FIG. 6 is thought to allow the Li⁺ to be transported between, and sequentially along, the plurality of electrode pairs. The applied current can be provided to the odd numbered (i.e. the first and third) electrode pairs, and the power can be drawn from even numbered (i.e. second and fourth) electrode pairs.

If the secondary battery 6 is circular, Li⁺ can be transported around and around the plurality of electrode pairs by repeatedly and sequentially performing steps a)-d). For example, when only the first electrode pair is activated and charged in step a), then Li⁺ is transported from the first cathode 14A, through the first separator 26A, and to the first anode 12A. When only the second electrode pair is then activated and discharged in step b), then Li⁺ is transported from the first anode 12A, through the porous first negative current collector 16A, through the second anode 12B, through the second separator 26B, and to the second cathode 14B. When only the third electrode pair is then activated and charged in step c), then Li⁺ is transported from the second cathode 14B, through the porous second positive current collector 18B, through the third cathode 14C, through the third separator 26C, and to the third anode 12C. When only the fourth electrode pair is then activated and discharged in step d), then Li⁺ is transported from the third anode 12C, through the porous second negative current collector 16B, through the fourth anode 12D, through the fourth separator 26D, and to the fourth cathode 14D. When the cycle is repeated and starts with the first electrode pair again being activated and charged in step a), then Li⁺ is transported from the fourth cathode 14D, through the porous positive current collector (i.e. 18A/18C, which are the same positive current collector), and back to the first cathode 14A as schematically depicted by the arrow between the fourth and first cathode 14D, 14A. The Li⁺ is then transported through the first cathode 14A, through the first separator 26A, and to the first anode 12A.

The circular transport of Li⁺ in one direction around the secondary battery 6 is thought to suppress dendrite formation on the anodes due to an imbalance in the preferential ion transport path through an asymmetry in the applied gradient of electrochemical potential.

Only the first electrode pair may be activated, and thus charged by receiving the applied current from a power source in step a), by the first switch 28 being in the first configuration and electrically contacting the first positive battery terminal 22A, and the third switch being in the first configuration and electrically contacting the first negative battery terminal 20A. Only the second electrode pair may be activated, and thus discharged by a load drawing power therefrom in step b), by the first switch 28 being in the second configuration and electrically contacting the second positive battery terminal 22B, and the third switch being in the first configuration and electrically contacting the first negative battery terminal 20A. Only the third electrode pair may be activated, and thus charged by receiving the applied current in step c), by the first switch 28 being in the second configuration and electrically contacting the second positive battery terminal 22B, and the third switch being in the second configuration and electrically contacting the second negative battery terminal 20B. Only the fourth electrode pair may be activated, and thus discharged by a load drawing power therefrom in step d), by the first switch 28 being in the first configuration and electrically contacting the first positive battery terminal 22A, and the third switch being in the second configuration and electrically contacting the second negative battery terminal 20B.

Activation of only individual ones of the electrode pairs can occur sequentially along the plurality of electrode pairs, i.e. starting with activation of only the first electrode pair, then activating only the second electrode pair, then activating only the third electrode pair, then activating only the fourth electrode pair, and then repeating the sequence of activation. Activation of only individual ones of the electrode pairs can also occur in a different order.

Sequential activation of individual ones of the electrode pairs may be performed on the secondary battery 6 having a circular configuration, wherein the first anode 12A and the fourth anode 12D are arranged on one current collector, i.e. the first positive current collector 18A and the third positive current collector 18C are the same positive current collector, and thus the first anode 12A and the fourth anode 12D together form a full anode by being physically connected to the same positive current collector. As shown schematically in FIG. 6 by the arrows, during charging Li⁺ is transported from the cathodes to the respective anodes. This is different from conventional secondary batteries 106, where usually the Li⁺ is delivered back and forth between the anode 112 and cathode 114 of one electrode pair via the electrolyte 124 between them during charging and discharging, and thus Li⁺ remains local to that specific electrode pair.

The method of using the secondary battery system 2 may include discharging the secondary battery 6. The secondary battery 6 may be discharged by activating (i.e. electrically connecting to the system terminals 8, 10) all or some of the electrode pairs. When the system terminals 8, 10 are electrically connected to a load, the load will draw power from (i.e. discharge) the activated electrode pairs, which can include both the first and second sets of electrode pairs, e.g. all the electrode pairs in the secondary battery 6.

This process of discharging the secondary battery 6 is shown schematically in FIGS. 7-8 by arrows representing a discharging electrochemical potential and the transport of Li⁺ between anodes 12A-D and the respective cathodes 14A-D, and wherein all of the electrode pairs are activated at the same time, and thus all of the electrode pairs can provide power to the load connected to the system terminals 8, 10. In FIG. 7, the first switch 28 is in the first configuration, and the second switch 30 is electrically contacting the second positive battery terminal 22B. In FIG. 8, the first switch 28 is in the first configuration, the second switch 30 is electrically contacting the second positive battery terminal 22B, the third switch 34 is in the first configuration, and the fourth switch 36 is electrically contacting the second negative battery terminal 20B.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A secondary battery comprising:
a first positive battery terminal;
a second positive battery terminal;
a negative battery terminal;
a first electrode pair electrically connected to the first positive battery terminal and the negative battery terminal; and
a second electrode pair electrically connected to the second positive battery terminal and the negative battery terminal.

2. The secondary battery according to claim 1, further comprising a controller configured to repeatedly and alternately electrically connect the first electrode pair and the second electrode pair to a first external circuit.

3. The secondary battery according to claim 2, wherein the controller electrically connects the first external circuit to the first electrode pair via the first positive battery terminal and the negative battery terminal, and electrically connects the first external circuit to the second electrode pair via the second positive battery terminal and the negative battery terminal.

4. The secondary battery according to claim 2, wherein when the controller electrically connects the first external circuit to one pair of the first and second electrode pairs, a second pair of the first and second electrode pairs is not electrically connected to the first external circuit.

5. The secondary battery according to claim 2, wherein electrical connection between the first external circuit and the first and second electrode pairs is alternated at or below a frequency at which dendrite growth is inhibited.

6. The secondary battery according to claim 2, wherein the controller is configured to simultaneously electrically connect the first and second electrode pairs to a second external circuit.

7. The secondary battery according to claim 1, wherein a first anode of the first electrode pair and a second anode of the second electrode pair are arranged on a same negative current collector electrically connected to the negative battery terminal.

8. The secondary battery according to claim 7, wherein the first anode of the first electrode pair and the second anode of the second electrode pair comprise lithium metal as an anode active material.

9. The secondary battery according to claim 7, wherein:
a first cathode of the first electrode pair is arranged on a first positive current collector electrically connected to the first positive battery terminal, and
a second cathode of the second electrode pair is arranged on a second positive current collector electrically connected to the second positive battery terminal.

10. The secondary battery according to claim 1, wherein the negative battery terminal is a first negative battery terminal, and wherein the secondary battery further comprises:
a second negative battery terminal,
a series of electrode pairs including the first electrode pair, the second electrode pair, a third electrode pair electrically connected to the second positive battery terminal and the second negative battery terminal, and a fourth electrode pair electrically connected to the first positive battery terminal and the second negative battery terminal, wherein a cathode of a last electrode pair in the series of electrode pairs and a cathode of the first electrode pair are arranged on a same positive current collector electrically connected to the first positive battery terminal, and
a controller configured to repeatedly and sequentially electrically connect the series of electrode pairs to an external circuit.

11. A secondary battery system comprising:
a negative system terminal;
a positive system terminal;
a first positive battery terminal;
a second positive battery terminal;
a series of electrode pairs, each electrode pair in the series of electrode pairs including an anode and a cathode, the series of electrode pairs including a first set of electrode pairs electrically connected to the first positive battery terminal, and a second set of electrode pairs electrically connected to the second positive battery terminal; and
a controller repeatedly and alternately electrically connecting the positive system terminal to a) the first positive battery terminal, and b) the second positive battery terminal.

12. The secondary battery system according to claim 11, wherein the negative system terminal is connected to each electrode pair in the series of electrode pairs.

13. The secondary battery system according to claim 11, wherein:
when the controller electrically connects the positive system terminal to the first positive battery terminal, the second positive battery terminal is not electrically connected to the positive system terminal; and
when the controller electrically connects the positive system terminal to the second positive battery terminal, the first positive battery terminal is not electrically connected to the positive system terminal.

14. The secondary battery system according to claim 11, wherein an electrical connection between the positive system terminal and the first and second positive battery terminals is alternated at or below a frequency at which dendrite growth is inhibited.

15. The secondary battery system according to claim 11, wherein the controller is configured to also simultaneously electrically connect the series of electrode pairs to the positive system terminal.

16. The secondary battery system according to claim 11, wherein anodes of adjacent electrode pairs in the series of electrode pairs are arranged on a common negative current collector.

17. The secondary battery system according to claim 16, wherein cathodes of adjacent electrode pairs in the series of electrode pairs are arranged on a common positive current collector.

18. The secondary battery system according to claim 11, wherein the anode comprises lithium metal as an anode active material.

19. A secondary battery system comprising:
a series of electrode pairs, each electrode pair in the series of electrode pairs including an anode and a cathode;
a negative system terminal;
a positive system terminal; and
a controller repeatedly and sequentially electrically connecting the series of electrode pairs to the positive system terminal and the negative system terminal;
wherein a) the cathode of a first electrode pair in the series of electrode pairs and the cathode of a last electrode pair in the series of electrode pairs are arranged on a common positive current collector, or b) the anode of the first electrode pair in the series of electrode pairs and the anode of the last electrode pair in the series of electrode pairs are arranged on a common negative current collector.

20. The secondary battery system according to claim 19, wherein the anode comprises lithium metal as an anode active material.
